(19) United States
(12) Patent Application Publication
(10) Pub. No.: US 2026/0184029 A1
(43) Pub. Date: Jul. 2, 2026

(54) METHOD OF MANUFACTURING A HOLLOW COMPOSITE STRUCTURE

(71) Applicant: Lockheed Martin Corporation, Bethesda, MD (US)

(72) Inventors: Felix Nhanchau Nguyen, Parker, CO (US); Yih-farn Chen, Shelton, CT (US); Michael Walter West, Shelton, CT (US); William P. Fallon, Wallingford, CT (US)

(73) Assignee: Lockheed Martin Corporation, Bethesda, MD (US)

(21) Appl. No.: 19/007,201

(22) Filed: Dec. 31, 2024

(51) Int. Cl. B29C 70/54; B29K 101/10; B29L 22/00

(52) U.S. Cl. CPC B29C 70/54; B29K 2101/10; B29L 2022/00

(57) ABSTRACT

A method of curing a hollow thermoset composite (HTSC) structure is disclosed herein. In some embodiments, the method includes debulking a hollow thermoset composite (HTSC) structure in a female tool to have a first target bulk factor and a first target degree of cure (DOC), and curing the debulked HTSC structure. In some embodiments, curing the debulked HTSC structure further includes: (a) curing the debulked HTSC structure to have a second target bulk factor, a second target DOC and a target viscosity, wherein the second target bulk factor and the second target DOC are greater than the first target bulk factor and first target DOC, respectively; and (b) curing the HTSC structure resulting from step (a) to have a final target DOC, wherein the final target DOC is greater than the second target DOC.

### FIELD OF THE DISCLOSURE

The present disclosure is related to a method of curing a hollow thermoset composite (HTSC) structure. The method produces an HTSC structure that has reduced void content.

### BACKGROUND OF THE DISCLOSURE

Thermoset composites are utilized in a variety of parts and/or products in various industries. For example, in the aerospace industry, thermoset composite parts may be used in the fuselage, wings, tail, rotor spar, and other parts of an aircraft or a rotorcraft. These parts are often large, and in some instances 10-100 feet or longer. Moreover, these parts have complex shapes, such as being hollow, having multiple cross-sections, having multiple thicknesses, having multiple corners, rotational twists, and/or uneven surfaces.

The manufacture of thermoset composite parts of this size and shape requires large assemblies, for example, mandrels to apply the thermoset composite in an uncured state to form the shape of the part, and tool to cure the thermoset composite. Due to the shape and size of the part, the tool, e.g., female tool, cannot provide heating and pressure distributed evenly or as required to every section of the part during cure to minimize or eliminate process-induced defects such as voids and wrinkles. For example, a flat surface of the part may contact a flat surface of the tool reasonably well under heat and pressure, but a curved surface of the part may be separated from a matching curved surface of the tool by a gap thus optimized curing is needed to close the gap prior to material gelation. Otherwise, pressurized heated air flow through the tool may be uneven due to the shape of the part, creating different rates of heat transfer in different sections of the part. This lack of even curing in the part results in voids and wrinkles in the thermoset composite. As a result, a high number of parts manufactured, e.g., up to 50% or more could be discarded due to manufacturing defects.

Processes have been developed to mitigate these problems. For example, in the current state-of-the art approach, a guessed cure cycle is applied to a cure equipment such as an autoclave, where a thermoset composite part is being cured, the part temperature can be monitored at multiple locations on the part during heating, Due to differences, such as part thickness, air flow and/or gaps between the tool and the part, the temperature can vary widely at the various locations being monitored. The cure is continued until the end of the applied cure cycle (a.k.a., cure profile) is reached. The final state of the part can be measured at the multiple locations to confirm success; otherwise, the next cure cycle is used and so on so forth until the part quality with the desired state of cure is achieved This approach is trial and error without any knowledge of the material state, such as the degree of cure, viscosity/flow, bulk factor/thickness and the similar or the like; thus extensive time and cost would be resulted to establish production cure conditions. Once production cure conditions are established and production become more stable, optionally the part temperature process could be reduced to monitoring high-risk locations or even eliminated, i.e., the established applied cure profile is only being monitored to be sure the set values are met. In some instances, abnormal cures such as power surge or outage, and mistakes from programming or loading and positioning the part in the cure environment could result in part scrap. In some instances, due to a higher production rate, more of the same or different cure equipment are needed. Unfortunately, the same costly trial-and-error approach is repeated for any of the same or different cure equipment. In other instances, for a given design change or a tool change the same costly trial-and-error approach is repeated regardless how small a change is.

There is a need in the art for improved manufacturing processes for thermoset composites, especially HTSC structures, for both initial production and continuous production via desired material states achievable at each segment of the cure cycle. The desired material states could be controlled and achieved with respect to changes from the part's geometry, tool, cure equipment, processing parameters, and/or other factors impacting heat transfer to the part.

### BRIEF SUMMARY OF DISCLOSURE

In an exemplary embodiment of the present disclosure, a method of curing a hollow thermoset composite (HTSC) structure comprising debulking a hollow thermoset composite (HTSC) structure in a female tool to have a first target bulk factor; and curing the debulked HTSC structure.

In some embodiments, debulking the HTSC structure to a first target bulk factor further comprises applying a debulking profile, wherein, during the debulking profile, the HTSC structure remains above a threshold temperature for an elapsed debulking time and the HTSC structure reaches a critical debulking temperature that is greater than the threshold temperature and reaches a critical debulking pressure; and proceeding to the curing step after the first target bulk factor has been reached.

In some embodiments, the debulked HTSC structure further comprises (a) curing the debulked HTSC structure to have a second target bulk factor, a second target DOC and a target viscosity, wherein the second target bulk factor and the second target DOC are greater than the first target bulk factor and first target DOC, respectively; and (b) curing the HTSC structure resulting from step (a) to have a final target DOC, wherein the final target DOC is greater than the second target DOC. In some embodiments, the method, wherein step (a) further comprises applying a first curing profile, wherein, during the first curing profile, the HTSC structure remains above the critical debulking temperature for an elapsed dwell time and the HTSC structure reaches a critical dwell temperature that is greater than the critical debulking temperature and reaches a critical dwell pressure; and proceeding to step (b) after the second target bulk factor and second target DOC has been reached.

In an exemplary embodiment of the present disclosure, a hollow thermoset composite structure prepared by the method herein.

In an exemplary embodiment of the present disclosure, a system comprises a female tool configured to receive a hollow thermoset composite (HTSC) structure, where the system is configured to perform the method disclosed herein.

### BRIEF SUMMARY OF DRAWINGS

To assist in understanding the present disclosure, reference is now made to the following description taken in conjunction with the accompanying drawings, in which:

FIG. 1 depicts a side schematic view of a female tool having a part disposed therein in accordance with some embodiments of the disclosure.

FIG. 2 depicts a top schematic view of a female tool having a part disposed therein in accordance with some embodiments of the disclosure.

FIG. 3 depicts a flow chart of a method for curing a hollow thermoset composite (HTSC) structure in accordance with some embodiments of the disclosure.

FIG. 4 depicts a flow chart for the curing step of the method of FIG. 3 in accordance with some embodiments of the disclosure.

FIG. 5 depicts a schematic temperature profile of the tool temperature and HTSC structure temperature in accordance with some embodiments of the disclosure.

FIG. 6 depicts a schematic temperature profile of a HTSC structure and the corresponding material state of the part in accordance with some embodiments of the disclosure.

### DESCRIPTION

Methods of curing a hollow HTSC structure are disclosed herein. The methods utilize knowledge of one or more material states of the HTSC structure during curing to produce an HTSC structure having a void content that is suitable for use.

It should be understood at the outset that, although example implementations of embodiments of the disclosure are illustrated below, the present disclosure may be implemented using any number of techniques, whether currently known or not. The present disclosure should in no way be limited to the example implementations, drawings, and techniques illustrated below. Additionally, the drawings are not necessarily drawn to scale.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The use of the terms “a” and “an” and “the” and similar referents in the context of describing the invention (especially in the context of the following statements) are to be construed to cover both the singular and the plural, unless otherwise indicated herein or clearly contradicted by context. As used in this document, “each” refers to each member of a set or each member of a subset of a set. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. Moreover, recitation of a range such as “of A to B”, or “from A to B”, or “between A to B”, or any recitation of range is intended to include the endpoints A and B. The use of any and all examples, or exemplary language (e.g., “such as”) provided herein, is intended merely to better explain the disclosure and does not pose a limitation on the scope of statements.

The use of terms ‘overlying’, ‘underlying’, ‘disposed on’ and similar referents in the context of the present disclosure are to be construed to cover both being separated and in direct contact with an adjacent structure. For example, a first layer ‘overlying’ or ‘disposed on’ a second layer means the first layer is above the second layer, where the first layer may be separated from the second layer by one or more intervening layers or the first layer may be in direct contact with the second layer. The terms ‘overlying’, ‘underlying’, ‘disposed’ are not intended to be construed to exclusively mean ‘in direct contact with’ an adjacent structure.

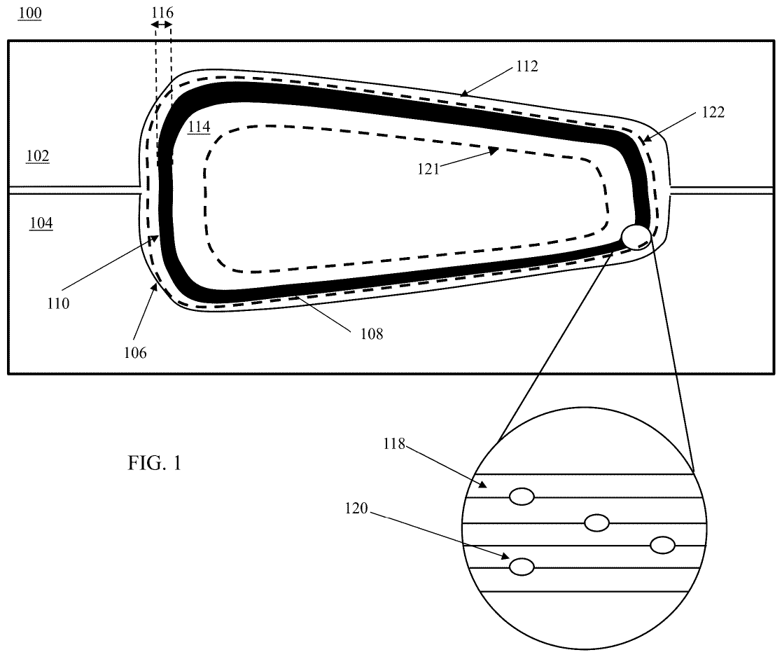

FIG. 1 depicts a side schematic view of a female tool having a part disposed therein in accordance with some embodiments of the disclosure. The female tool 100 may be a clam shell design having a first half 102 and a second half 104 that form a cavity 106. The cavity 106 can surround an HTSC structure 108. Due to the HTSC structure 108 being multi-faceted, one portion 110 of the HTSC structure 108 may be spaced apart from walls of the cavity 106 relative to another portion 112 of the HTSC structure 108.

The HTSC structure 108 may have a cavity 114 extending therethrough and along a length thereof. The cross-section of the cavity 114 can be non-uniform along the length of the HTSC structure. For example, the cross-section of the cavity can narrow or widen gradually or abruptly along the length of the HTSC structure. Though illustrated in FIG. 1 as an irregularly shaped cross-section, the cavity can have any suitable cross-section or plurality of cross-sections having the same or different shapes. For example, cross-sections along the length of the HTSC structure can be irregular, circular, square, rectangular, trapezoidal, and the like. In some embodiments, the part may have at least two different cross-sections along the length thereof. Differences can include shape, size, wall thickness, and/or the like. In some embodiments, a length of the HTSC structure may range from about 2 feet to about 70 feet. In some embodiments, the length may range from about 2 feet to about 35 feet. In some embodiments, a cross-section of the cavity 114 may range from about 1 inch to about 10 inches in height and about 5 inches to about 40 inches in width. In some embodiments, the height may range from about 2 inches to about 8 inches in height. In some embodiments, the width may range from about 10 inches to about 25 inches.

A wall 116 of the HTSC structure 108 can have a uniform and/or uneven thickness. For example, thickness of the wall can vary along a given cross-section of the HTSC structure, and/or vary between cross-sections of the part along the length of the HTSC structure. As shown in FIG. 1 (inset), the wall 116 may comprise a plurality of plies 118. During conventional curing, voids and/or wrinkles can form between plies and/or inside plies. For example, as shown in FIG. 1, voids 120 can form between plies making the HTSC structure unsuitable for use. The methods of the present disclosure reduce or prevent voids and/or wrinkles from forming during curing of the HTSC structure.

The plies 118 may be a composite material. The composite material includes a thermoset resin composition. The composite material can further include a structural member, such as fibers and/or particles. The thermoset resin composition can be coated on and/or impregnated in the structural member. The thermoset resin composition can be cured by the methods of the present disclosure to form an HTSC structure.

The thermoset resin composition can comprise any suitable resin. Non-limiting and exemplary thermoset resins can include epoxy resins, epoxy novolac resins, ester resins, vinyl ester resins, cyanate ester resins, maleimide resins, bismaleimide (BMI) resins, bismaleimide-triazine resins, phenolic resins, novolac resins, resorcinolic resins, unsaturated polyester resins, diallylphthalate resins, urea resins, melamine resins, benzoxazine resins, polyimide resins, polyurethanes, their derivatives, or mixtures thereof. In some embodiments, the thermoset resin can be included in the plies with one or more of a curing agent, a hardener or a crosslinking agent. The hardener may be used in a stoichiometric or non-stoichiometric ration relative to a resin. In some embodiments, the hardener may be included in an amount to completely crosslink with a corresponding thermoset resin, i.e., a stoichiometric ratio between the thermoset resin equivalent weight and the hardener equivalent weight. In some embodiments, the hardener may be included in an amount different from a stoichiometric ratio or up to about 75 parts by weight per 100 parts by weight of total thermoset resin (75 phr).

Suitable hardeners for epoxy resins include, but are not limited to, polyamides, dicyandiamide [DICY], amidoamines (e.g., aromatic amidoamines such as aminobenzamides, aminobenzanilides, and aromatic aminobenzenesulfonamides), diamines (e.g., diaminodiphenylmethane, diaminodiphenylsulfone [DDS] such as Aradur® 9664-1 and Aradur® 9719-1 from Huntsman Advanced Materials), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines such as tetramethylguanidine, anhydrides (e.g., methylhexahydrophthalic anhydride), hydrazides (e.g., adipic acid dihydrazides [ADH], isophthalic dihydrazides [IDH], sebacic acid dihydrazides [SDH], valine dihydrazides [VDH], carbodihydrazides [CDH], icosanedioic acid dihydrazides, phthalic dihydrazide, terephthalic dihydrazide, 1,2,3-benzenetricarboxic trihydrazide, benzoic acid hydrazide, aliphatic monohydrazides, aliphatic trihydrazides, aliphatic tetrahydrazides, and aromatic monohydrazides, aromatic dihydrazides, aromatic trihydrazides, aromatic tetrahydrazides, p-toluenesulfonylhydrazide, benzenesulifinic hydrazide, benzenesulfonyl hydrazide, sulfuryl hydrazide, and phosphoric acid trihydrazide, 2-aminobenzoic hydrazide or 4-aminobenzoic hydrazide), hydrazines (e.g., phenylhydrazine, naphthalene hydrazine, 1-hexylhydrazine, p-phenylenebis(hydrazine), 1,6-hexamethylene dihydrazine, and 1,2-diphenyl hydrazine), phenol-novolac resins and cresol-novolac resins, carboxylic acid amides, polyphenol compounds, polysulfides and mercaptans, and Lewis acids and bases (e.g., boron trifluoride ethylamine, tris-(diethylaminomethyl) phenol), their derivatives, or combinations thereof.

In some embodiments, the resin composition may include an additive. In some embodiments, the resin composition comprises from 0.1% to 40% (w/w) of a polymer additive, based on a total weight of the resin. In some embodiments, the resin includes at least 0.1% (w/w) of the polymer additive, or at least 1%, at least 2%, at least 3%, at least 4%, or at least 5% to less than 10%, less than 11%, less than 12%, less than 13%, less than 14%, or less than 40% (w/w) of the polymer additive, based on the total weight of the resin.

Exemplary additives include thermoplastics, fillers, cure accelerators, or combinations thereof. Suitable fillers include, but are not limited to, interpenetration network polymers, elastomers, branched polymers, hyperbranched polymers, dendrimers, rubbery polymers, rubbery copolymers, block copolymers, core-shell particles, oxides or inorganic materials such as silica, clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization, or combinations thereof. Suitable thermoplastics include polyvinyl formals, polyamides, polycarbonates, polyacetals, polyphenyleneoxides, polyphenylene sulfides, polyarylates, polyesters, polyamideimides, polyimides, polyetherimides, polyimides having phenyltrimethylindane structure, polysulfones, polyethersulfones, polyetherketones, polyetheretherketones, polyaryletherketone, polyaramids, polyethernitriles, polybenzimidazoles, their derivatives or their mixtures thereof. Suitable cure accelerators for epoxy resins include, but are not limited to, urea compounds, sulfonate compounds, boron trifluoride piperidine, p-t-butylcatechol, sulfonate compounds, tertiary amines or salts thereof, imidazoles or salts thereof, phosphorus curing accelerators, metal carboxylates, Lewis or Bronsted acids or salts thereof, or combinations thereof.

The fiber can be in any suitable shape and/or form. Non-limiting and exemplary fibers can include carbon fibers, glass fibers, aramid fibers, graphite fibers, boron fibers, metal fibers, natural/bio fibers, other organic or inorganic fibers, or combinations thereof. The fibers can be arranged in any suitable configuration, such as unidirectional, biaxial, triaxial, quadaxial, randomly oriented, woven, non-woven, non-crimp, braided, bundled, matted, or the like.

The wall 116 can include any suitable number of plies 118 to achieve a desired thickness, and/or structural characteristic. In some embodiments, the wall 116 may be up to about 5 inches in thickness. Any suitable number of plies 118 may be utilized to manufacture the wall 116 to a desired thickness. In some embodiments, a number of plies 118 may range from about 10 to about 1500 plies. Each ply 118 may range in thickness from about 0.001 to about 0.05 inches. Optionally, a core material can be used in addition to plies to achieve the desired thickness and/or structural characteristics of the wall 116. Suitable core materials included, but not limited to, open and closed cell structured foams, such as polyvinylchloride, polyurethane, polyethylene, or polystyrene foams, balsa wood, syntactic foams, honeycombs, aluminum, and fiber or other reinforced polymer composites.

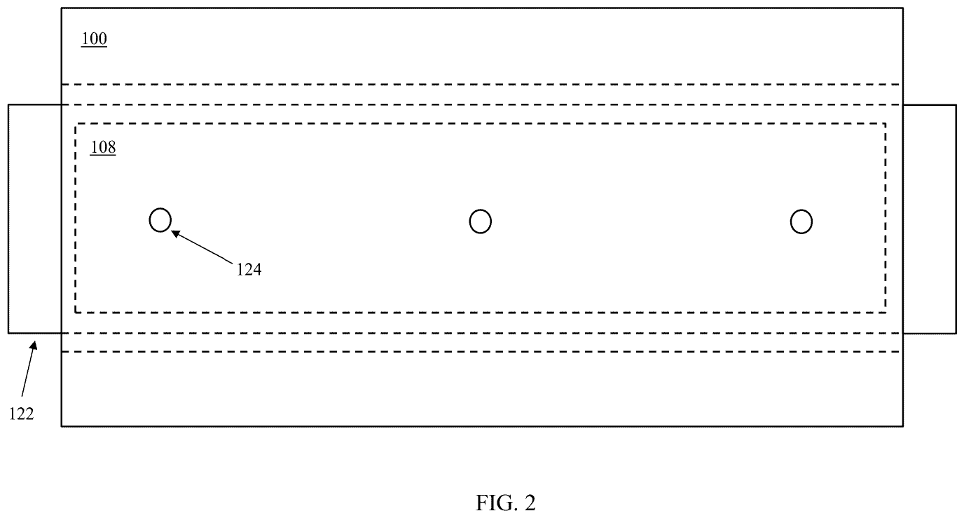

FIG. 2 depicts a top schematic view of the female tool 100 having the HTSC structure 108 disposed therein in accordance with some embodiments of the disclosure. The female tool 100 may include one or more components to provide pressure, temperature, shield the HTSC structure from contaminants, and the like. For example, the tool 100 may include a first container 121 (depicted in FIG. 1) disposed in the cavity 114 of the HTSC structure. The tool 100 may include a second container 122, wherein the second container 122 surrounds the HTSC structure 108 having the first container 121 in the cavity 114 thereof. The second container 122 including the HTSC structure 108 and the first container 121 within is placed in the cavity of the female tool 100 for debulking and curing as discussed herein. Although depicted in FIGS. 1-2 as being disposed inside the tool 100, the second container 122 may, in some embodiments, enclose the tool 100 with the HTSC structure 108 and first container 121 therein (not shown).

The first container 121 may be a bag or other amorphously shaped container that may be contained within the cavity 114 of the HTSC structure 108 for protecting the HTSC structure 108 from contaminants and applying heated and/or pressurized air flowing through the first container front one or more inlets to one or more outlets. For example, the pressurized air flowing through the first container 121 may expand the first container such that the wall 116 of the HTSC structure 108 is pushed against the tool surface.

The second container 122 may be a bag or other amorphously shaped container that surrounds the part 108. The container can include inlets and outlets for pressurizing the container, providing air flow through the container. As shown in FIG. 2, temperature sensors 124 may be provide at multiple locations along the HTSC structure 108, either on the inner or outer surface or underneath one or more plies of the HTSC structure 108. The temperature sensors 124 may contact locations on the HTSC structure to monitor temperature at the locations during curing. Alternatively, or in combination the temperature sensors 124 may monitor ambient air temperature in the first and/or second container 121, 122. In some embodiments, (not shown) temperature sensors may be embedded in the structure 108 itself. After curing the embedded temperature sensor may remain in the structure 108, or be removed from the structure 108. For example, the temperature sensor may be embedded in a portion of the structure 108 that may be trimmed and/or removed after curing is completed.

Prior to inclusion in the containers 121, 122, the HTSC structure 108 may be shaped in an uncured state using a mandrel (not shown). The mandrel may be shaped for a given part being cured. The mandrel design may be changed based on the shape of the part. In some embodiments, the mandrel may be in the shape of the cavity 114 of the HTSC structure 108. To shape the HTSC structure 108, the plurality of plies 118 can be wrapped around the mandrel to form the walls 116 of the HTSC structure 108 in an uncured state. The mandrel may include a mechanism for collapse and can be collapsed and removed from the shaped and uncured HTSC structure 108 prior to inserting the part 108 in the second container 122. Further, the mandrel may also be removed by physical, thermal/heat, mechanical or chemical extraction.

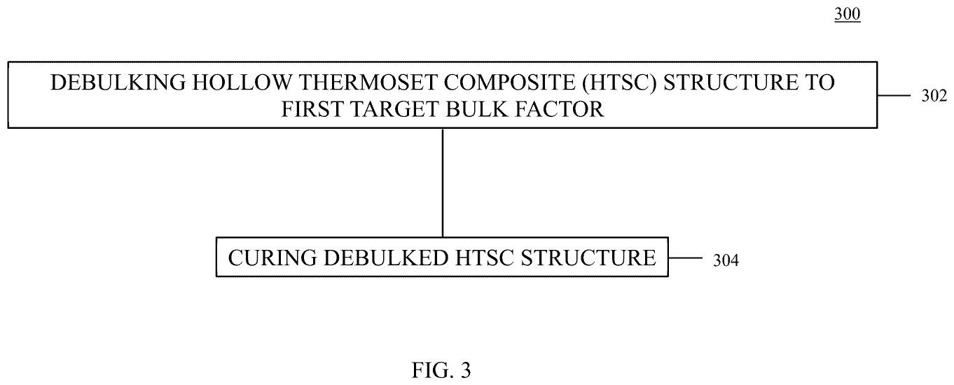

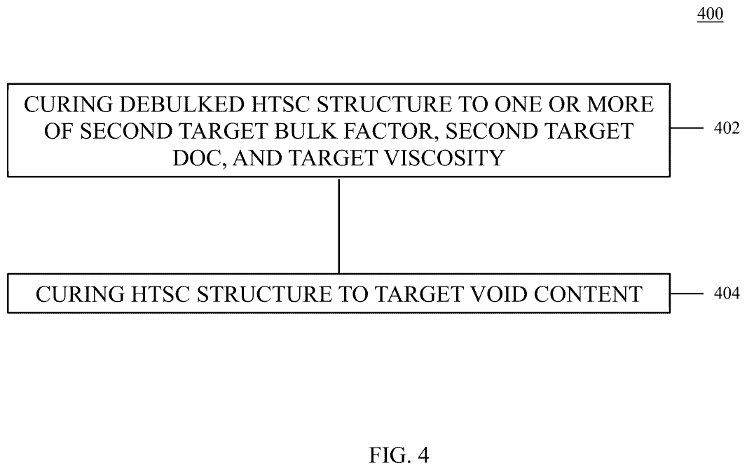

FIG. 3 depicts a flow chart of a method 300 for curing a hollow thermoset composite (HTSC) structure in accordance with some embodiments of the disclosure, for example a composite material comprising an epoxy resin composition as described herein. At 302, the HTSC structure is debulked in the female tool. After debulking, the HTSC structure is then cured at 304. The curing step 304 may include two curing steps, a first curing step 402 (e.g., an intermediate curing step) and a second curing step 404 (e.g., a final curing step) as shown in FIG. 4 and discussed below. In some embodiments the first curing step 402 might include more than one intermediate curing steps as long as the required material states are reached at the end of the first cure step 402 prior to proceeding to the second cure step 404. Each of the debulking step 302, the first curing step 402, and final curing step 404 include at least an elapsed time that temperature remains above a threshold temperature, and a critical temperature that the HTSC structure should achieve during the step 302, 402, and 404. The critical temperature and elapsed time can be determined by process correlation as discussed herein such that the HTSC structure achieves a desired material state at the conclusion of each step 302, 402, and 404.

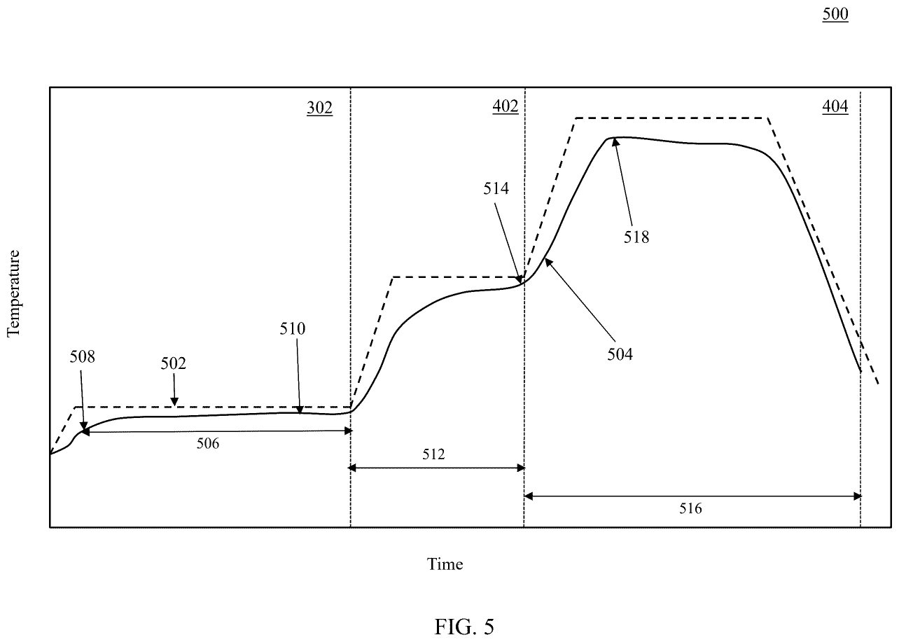

FIG. 5 depicts a schematic cure profile, wherein a set temperature profile 502 is programmed into an autoclave and results in a cure profile 504 of the HTSC structure in accordance with some embodiments of the disclosure. An air temperature profile (not shown) could be tracing the set temperature profile 502 and a tool temperature profile (not shown) might be lagging the HTSC structure temperature profile 504. The cure profile 504 have three regions corresponding to the debulking step 302 (e.g., a debulking profile), the first curing step 402 (e.g., a first cure profile) and the second curing step 404 (e.g., a final cure profile), respectively.

The debulking step 302 has an elapsed time 506 defined from the time the HTSC structure reaches and remains and remains above a threshold temperature 508 to the end of the debulking step 302. During the debulking step 302, the part reaches a critical debulking temperature 510 which can occur at any point during the elapsed time 506. As depicted in FIG. 5, the critical debulking temperature 510 occurs prior to the end of the elapsed time 506. At the end of the elapsed time 506 for the debulking step 302, the HTSC structure has reached one or more target material states which are discussed further below.

The threshold temperature may be a temperature above which processing and curing of the thermoset composite composition can occur or occurs within an economically viable time frame. The threshold temperature 508 may be based, at least in part, on one or more of the identity of the thermoset resin composition, resin systems, number of plies, ply orientation, fiber volume, amount of thermoset resin relative to other materials, such as a fiber, in the thermoset composite composition, achieving specification requirements, geometry and/or configuration of the part and/or tool, and the like. In some embodiments, the threshold temperature may range from about 90° F. to about 175° F. In some embodiments, the threshold temperature may range from about 100° F. to about 150° F. Air temperature surrounding the part may exceed the threshold temperature while temperature of the tool might be similar, lower, or higher than the threshold temperature.

The elapsed time 506 and the critical debulking temperature 510 may be in any suitable combination to achieve the desired material state at the conclusion of the debulking step 302. As discussed below, the elapsed time 506 and critical debulking temperature 510 may be selected based on process correlation to achieve the desired material state, for example, a bulk factor and/or degree of cure of the HTSC structure at the conclusion of the debulking step 302. In some embodiments, the elapsed time 506 may range from about 1 hour to about 4 hours. In some embodiments, the elapsed time 506 may be longer than about 4 hours provided the desired material state is met. In some embodiments, the critical debulking temperature 510 may range from about 90° F. to about 225° F., about 100° F. to about 175° F. or about 115° F. to about 150° F. In some embodiments, the critical debulking temperature 510 may be the same as the threshold temperature 508. In some embodiments, the critical debulking temperature 510 may be the maximum temperature achieved during the debulking step 302. The desired material state (i.e., the bulk factor and degree of cure) at the end of the debulking step 302 may set up the conditions to achieve the next material state to be achieved at the end of the first curing step 402, and in turn the final material state to be achieved at the end of the second cure step 404, leading to reduced void content of the cured HTSC.

The first curing step 402 has an elapsed time 512 defined from the end of the debulking step 302 to the end of the first curing step 402. During the elapsed time 512, the HTSC structure will remain above the threshold temperature 508. During the first curing step 402, the HTSC structure reaches a critical dwell temperature 514 which can occur at any point of the elapsed time 512 after the end of the elapsed time 506 (e.g., after the debulking step 302 has ended). As depicted in FIG. 5, the critical dwell temperature 514 coincides with the end of the elapsed time 512. However, this is merely exemplary and the critical dwell temperature 514 can occur before the end of the elapsed time 512. At the end of the elapsed time 512 for the first curing step 402, the HTSC structure has reached one or more target material states which are discussed further below.

The elapsed time 512 and the critical dwell temperature 514 may be in any suitable combination to achieve the desired material state at the conclusion of the first curing step. As discussed below, the elapsed time 512 and critical dwell temperature 514 may be selected based on process correlation to achieve the desired material state, for example, a bulk factor and/or degree of cure and/or viscosity of the HTSC structure at the conclusion of the first curing step 402. In some embodiments, the elapsed time 512 may range from about 1 hour to about 12 hours, about 1 hour to about 6 hours, or about 1 hour to about 3 hours The elapsed time may depend on the configuration of the HTSC structure, configuration of material, e.g., identity of material, number of plies, and the like, configuration of the tool, configuration of the cure equipment, and other factors impacting heat transfer to the part. In some embodiments, the critical dwell temperature 514 may range from about 150° F. to about 330° F., about 175° F. to about 310° F., or about 200° F. to about 290° F. In some embodiments, in case of exotherm or runaway reaction, the critical dwell temperature might exceed about 330° F. up to 450° F. for a short period of time. In some embodiments, the critical dwell temperature 514 may be the maximum temperature achieved during the first curing step 402.

The second curing step 404 has an elapsed time 516 defined from the end of the first curing step 402 to the end of the second curing step 404. At the onset of the second curing step 404, the HTSC structure is above the threshold temperature 508. In some embodiments, the HTSC structure may be cooled below the threshold temperature 508 by the end of the elapsed time 516. During the second curing step 404, the part reaches a critical final dwell temperature 518 which can occur at any point of the elapsed time 516 after the end of the elapsed time 512 (e.g., after the first curing step 402 has ended.) As depicted in FIG. 5, the critical final dwell temperature 518 occurs before the end of the elapsed time 516. At the end of the elapsed time 516 for the second curing step 404, the part may have been cooled to the threshold temperature. In some embodiments, the part may have cooled to a temperature ranging from about 70° F. to about 200° F. At the end of the elapsed time 516 for the second curing step 404, the HTSC structure has reached one or more target material states which are discussed further below.

The elapsed time 516 and the critical final dwell temperature 518 may be in any suitable combination to achieve the desired material state at the conclusion of the final curing step. As discussed below, the elapsed time 516 and critical final dwell temperature 518 may be selected based on process correlation to achieve the desired material state, for example, a void content of the HTSC structure at the conclusion of the second curing step 404. In some embodiments, the elapsed time 516 may range from about 2 hour to about 24 hours or about 2 to about 6 hours. In some embodiments, the critical final dwell temperature 518 may range from about 310° F. to about 400° F. In some embodiments, in case of exotherm or runaway reaction, the critical final dwell temperature might exceed about 400° F. up to 450° F. for a short period of time. In some embodiments, the critical final dwell temperature 518 may be the maximum temperature achieved during the second curing step 404.

In some embodiments, the above mentioned critical debulking temperature 510, the critical dwell temperature 514 and the critical final dwell temperature 518 may be higher or lower for a composite material comprising a thermoset resin composition different from the epoxy resin composition. For example, a composite material comprising a BMI resin composition might have the critical debulking temperature 510, the critical dwell temperature 514 and the critical final dwell temperature in the ranges of about 115° F. to about 180° F., about 250° F. to about 350° F., about 375° F. to about 500° F., respectively. In addition, exotherm temperature might exceed 500 OF.

In some embodiments, the debulking step and the first and the second cure step may be performed in the same or different cure equipment. For example, the debulking step may be performed in one cure equipment such as an autoclave or another equipment providing a sufficient pressure up to 150 psi while the first and the second cure step might be performed in another cure equipment such as an autoclave or another equipment providing a sufficient pressure up to 250 psi.

During the debulking step 302, the first curing step 402, and the second curing step 404, the HTSC structure can be monitored at a number of locations using temperature sensors as discussed herein. Moreover, due the shape of the HTSC structure, there may be variation in temperature at one or more of the locations being monitored. For example, different locations could reach the threshold temperature or the critical temperature at different times. Accordingly, the elapsed time at each location could begin and end at different times in each location. Thus, based on the monitored temperatures at each location of the HTSC structure, it must be decided, for example, when to increase the temperature of the tool to begin the next process step. In some embodiments, a selection location could be monitored for the temperature of the HTSC structure, and the temperature of the tool can be increased to begin the next process step based on the temperature monitored at the selection location. In some embodiments, an average of the temperatures from all locations can be determined, and the temperature of the tool can be increased to being the next process step based on the average temperature at all the locations being monitored. In some embodiments, the lowest temperature measured at all the locations can be determined, and the temperature of the tool can be increased to begin the next process step based on the lowest temperature being monitored.

Returning to FIG. 3, during the debulking step 302, time, temperature, and/or pressure are applied such that the HTSC structure ends the debulking step having one or more material states. In the case of the debulking step, the HTSC structure may end the debulking step at a first target bulk factor. In some embodiments, the HTSC structure may further end the debulking step at a first target degree of cure (DOC). The bulk factor may be the difference in the volume and/or the difference in thickness of the thermoset composite relative to the volume and/or thickness of the thermoset composite in the final cured state. For example, a bulk factor of 20% may be a thermoset composite having a volume that is 20% greater than the volume of the thermoset composite in the final cured state. The bulk factor of an uncured or partially cured thermoset composite can range from about 0.5% to about 100%. In some embodiments, the bulk factor of an uncured or partially cured thermoset composite may range from about 1% to about 50%. In some embodiments, the bulk factor of an uncured or partially cured thermoset composite may range from about 5% to about 20%. The DOC may be the portion of the thermoset composite in the cured state relative to the total initially uncured thermoset composite, or a portion of crosslinks between the resin and the hardener are formed relative to the total crosslinks at the end of the final cure to achieve the final cured state. For example, a 20% DOC may mean 20% of the crosslinks are form, and 90% DOC may mean 90% of the crosslinks are formed. The bulk factor and/or the DOC can vary throughout the composite structure and may not necessarily be uniform throughout the composite structure. For example, the bulk factor and/or DOC may be monitored at several locations, based on temperature, as discussed herein.

The debulk step 302 may begin by applying a debulking profile, wherein, during the debulking profile, the HTSC structure remains above a threshold temperature for an elapsed debulking time and the HTSC structure reaches a critical debulking temperature that is greater than the threshold temperature and reaches a critical debulking pressure. The HTSC structure may be heated in the female tool for the elapsed time during which the HTSC structure reaches the critical debulking temperature and critical debulking pressure at the locations being measured on the HTSC structure.

In some embodiments, the elapsed time, the critical temperature, and critical pressure may be determined to produce a first target bulk factor in the HTSC structure. A bulk factor process correlation determines the elapsed time, the critical temperature, and the critical pressure that are applied to achieve the first target bulk factor in the HTSC structure. The bulk factor process correlation is determined from at least one of a semi-empirical bulk factor model of the HTSC structure, a plurality of bulk factor simulations of the HTSC structure for a plurality of bulk factor distinct process conditions; or experimental measurement.

A semi-empirical bulk factor model may include a set of empirical equations describes the elastic stress-strain relationship in multiple orientations. The evolution of stresses and strains can describe how the composite structure will deform (i.e. consolidate) over time and is dependent upon external forces being sufficient to overcome the fiber-bed stiffness.

Relevant parameters considered in the semi-empirical bulk factor model may include fiber volume, Poisson's ratio, longitudinal elastic modulus, through thickness elastic modulus, transverse elastic modulus, viscosity, empirical constants, and fiber bed stress, bulk and shear moduli, temperature and thermal history, pressure and pressure history, and/or boundary conditions, e.g. tool contact, friction, and the like.

Exemplary modeling and simulation may include thermo-chemical, flow-compaction, and stress-deformation models.

A thermos-chemical model may include a solid computer aided design (CAD) model, cure cycle recipe, e.g., ramp rates, dwell temperatures, and dwell durations, material assignment, material properties, boundary conditions, e.g., initial temperature, heat transfer coefficient(s), contact definition(s)).

A flow-compaction model may include thermo-chemical outputs as inputs, e.g. thermal history, degree of cure, and the like, pressure control loop, boundary conditions, e.g., contact, pressure surface, friction, displacement constraints, and the like.

A stress-deformation model may include the same inputs as the flow-compaction model.

The bulk factor simulation may include thermal chemical and flow compaction models. Examples of commercial software packages include RAVEN and COMPRO available from Convergent Manufacturing Technologies. The plurality of bulk factor distinct process conditions may include at least one of a plurality of different heated environment temperatures utilized during heating the HTSC structure providing different heat transfer coefficients between the heated environment and the HTSC structure, a plurality of different heating rates for the HTSC structure, a plurality of different pressures applied to the HTSC structure, a plurality of different materials and thicknesses for the HTSC structure, or a plurality of different materials, thicknesses, thermal conductivity, heat capacity and density for the female tool.

Experimental measure may include validation or correlation of a digital simulation (e.g., thermo-chemical, flow-compaction, or stress-deformation models) against experimental data. In some embodiments, experimental measure may include providing raw materials, e.g., composite prepreg, tool, vacuum bag, mold release, and the like, and layering composite plies in a predetermined manner to create an uncured composite structure. The uncured composite structure may be measured, e.g., length, thickness, circumference, and the like, to obtain physical measurements prior to curing. The uncured composite structure may then be cured, e.g., partially or fully, and the physical measurements on the partially or fully cured composite structure may be repeated. A CAD model of the tool and composite structure can be created. Preferably, the CAD model of the uncured composite structure will precisely match the physical measurements collected experimentally prior to curing. The tool and composite structure CAD models may be combined, material properties and boundary conditions may be assigned, and the desired simulations (e.g., thermo-chemical, flow-compaction, or stress-deformation) may be executed. The simulated bulk factor outputs may be compared against the physical measurements such as local thicknesses, averaged thicknesses, volume of the uncured, debulked, and partially or fully cured composite structure. Additional laboratory testing may be performed, if necessary, using specimens extracted from the cured composite structure to validate certain simulated bulk factor results, e.g. DSC may be used to validate degree of cure predictions. Based on the comparison, simulation parameters may be updated to produce more accurate predictions.

In some embodiments, the critical debulking temperature and the elapsed debulking time may be further selected to produce a first target degree of cure (DOC) in the HTSC structure. A DOC process correlation determines a relationship between the DOC in the HTSC structure and temperature and elapsed time. The critical debulking temperature and the elapsed debulking time are further selected based on the DOC process correlation to produce the first target DOC in the HTSC structure.

The DOC process correlation may be determined from at least one of a calibration curve having a functional relation between DOC and temperature and time, a lookup table having paired values of the critical debulking temperature and the elapsed debulking time that produce the first target DOC, a semi-empirical DOC model of the HTSC structure, a plurality of DOC simulations of the HTSC structure for a plurality of DOC distinct process conditions, wherein the DOC simulations include thermal chemical models, or experimental measurement.

A semi-empirical DOC model may be utilized to determine the degree of cure evolution as a function of time and geometry. The model may include density, cure kinetics, specific heat, conductivity, viscosity, coefficient of thermal expansion, cure shrinkage, modulus, and Poisson's ratio models. Relevant parameters of the model may include reaction, activation energy, glass transition temperature, temperature difference, diffusion kinetics. The cure kinetics model describes the rate at which polymerization of the matrix occurs and may include parameters such as the heat of reaction, pre-exponential factor, activation energy, gas constant, and/or temperature.

The DOC simulation may include thermal chemical models. Examples of commercial software packages include RAVEN and COMPRO available from Convergent Manufacturing Technologies. The plurality of DOC distinct process conditions includes at least one of a plurality of different heated environment temperatures utilized during heating the HTSC structure providing different heat transfer coefficients between the heated environment and the HTSC structure, a plurality of different heating rates for the HTSC structure, a plurality of different materials and thicknesses for the HTSC structure, a plurality of different materials, thicknesses, thermal conductivity, heat capacity and density for the female tool.

Experimental measure may include experimentally validating the intended degree of cure based on process correlation. Experimental validation may be performed using differential scanning calorimetry (DSC). Once the degree of cure of a cured specimen has been determined, that data is used to validate a simulation prediction. If the simulation prediction is found to be accurate, changes to the simulation inputs (e.g., time, temperature, pressure, geometry, and the like) can be made and still yield accurate outputs. Simulations can be used for new parts, new cure cycles, and the like and provide the same results one would obtain had the part been destructively analyzed (e.g., by DSC).

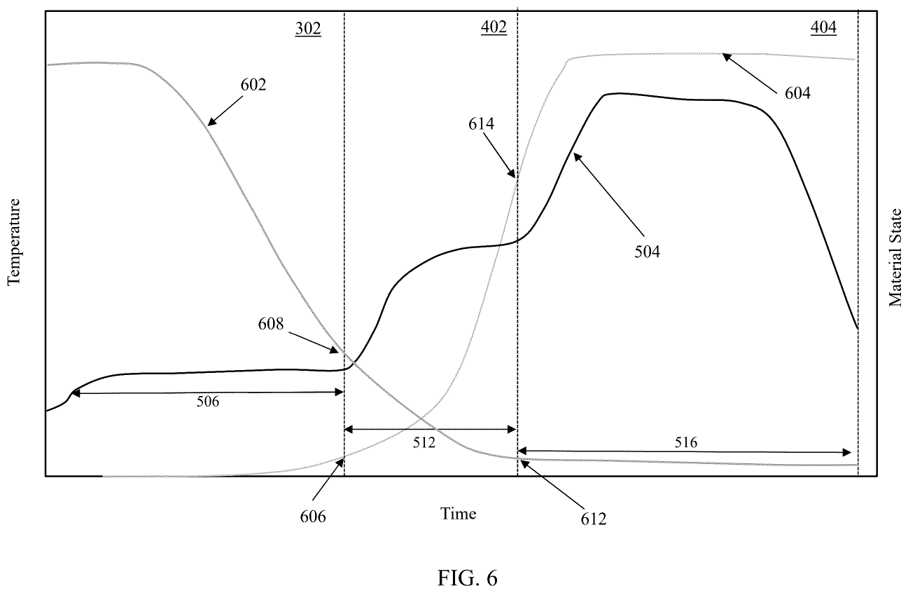

Referring to FIG. 6, the material state, such as DOC and bulk factor are dependent on the thermal and stress-strain history of the HTSC structure, respectively, considering the geometry and/or materials of the structure and the tool, e.g., identity and/or structure of ply material, such as unidirectional or weave, material orientation, volume of fiber in the plies, gaps between the structure and the tool, and the like. FIG. 6 depicts the temperature profile 504 of the HTSC structure and corresponding material state profiles, such as a bulk factor profile 602 and a degree of cure profile 604. For example, the debulking step 302 in FIG. 6 has a thermal and stress-strain history influenced by the threshold temperature, elapsed time, ramp rate, critical temperature, and/or critical pressure. The thermal and stress-strain history will result in the HTSC structure having a bulking factor 608 and a DOC 606 at the end of the elapsed time 506 of the debulking step 302, where both the DOC 606 and debulking factor 608 are both dependent on the thermal and stress-strain history of the HTSC structure, respectively that occurs during the debulking step 302.

Prior to production, to determine the first target bulk factor and the first target degree of cure, the bulk factor process correlation and the degree of cure process correlation are utilized to determine an elapsed time, a critical temperature, and/or a critical pressure that would be needed to produce the first target bulk factor (e.g., bulk factor 608) and the first target DOC (e.g., DOC 606). For example, the bulk factor process correlation may be used to select a target bulk factor (e.g., bulk factor 608). Then, the elapsed time (e.g., elapsed time 506), critical temperature (e.g., critical temperature 510) needed to produce the target bulk factor may be considered in the degree of cure process correlation to determine the degree of cure (e.g., DOC 606) that results from that elapsed time and critical temperature. If the degree of cure that the elapsed time and critical temperature would produce in the HTSC structure is not desired, then a different target bulk factor may be selected such that a desired combination of the first target bulk factor and the first degree of cure is achieved at the end of the debulking step 302. The desired combination of first target bulk factor and first target degree of cure at the end of the debulking step 302 are selected to produce, as described herein, a desired combination of a second target bulk factor, a second target degree of cure, and a target viscosity at the end of a first curing step 402, which in turn are selected, as described herein, to produce a desired void content at the end of a second cure step 404 of less than about 5%, less than about 3%, less than about 2%, or less than about 1%.

Alternatively, there may be different parameters or thermal histories, e.g., different combinations of elapsed time, ramp rate, critical temperature, critical pressure, and/or the like, that may produce the same target bulk factor. For example, if the selected parameters to produce a target bulk factor results in a degree of cure that is not desired, then a different combination of parameters (that result in the same target bulk factor) may be selected such a desired degree of cure is achieved at the end of the debulking step 302.

Upon completion of the debulking step 302, the HTSC structure may have a bulk factor of less than about 90% and/or a DOC of less than about 5%. Prior to the debulking step 302, the HTSC structure may have a bulk factor of about 100% and/or a DOC of less than about 0.5%. The bulk factor prior to the debulking step may be greater than 80% in some embodiments. The bulk factor may depend on geometry, number of plies, ply orientation, and the like. In some embodiments, the bulk factor at completion of the debulking step 302 may be less than about 80% and greater than about 5%. In some embodiments, the DOC at completion of the debulking step 302 may range from about 1% to less than about 10%. In some embodiments, the DOC at completion of the debulking step 302 may be less than about 5%.

In the absence of the high pressure warm debulk, the HTSC structure has an increased probability of containing entrapped gas within the HTSC structure and containing resin rich regions, non-conforming dimensional requirements due to lack of consolidation.

Returning to FIG. 3, upon completion of the debulking step 302, the debulked HTSC structure is cured at 304. The curing step 304 may include the first curing step 402 (e.g., an intermediate dwell) and the second curing step 404 (e.g., a final dwell) as depicted in the flow chart in FIG. 4.

The first curing step 402 may follow from the debulking step 302, where the HTSC structure has the first target bulk factor and first degree of cure at the beginning of the first curing step 402. At 402, the HTSC structure may be cured to have the second target bulk factor, the second target degree of cure, and the target viscosity (e.g. minimum viscosity, viscosity at a specific temperature and/or time during curing 402). The second target bulk factor may be lower than the first target bulk factor. The second target degree of cure may be greater than the first target degree of cure. The target viscosity may be selected to minimize degree of cure and maximize HTSC structure consolidation (i.e., reduce the initial bulk factor) while promoting resin flow or minimizing its viscosity. For example, reducing a minimum viscosity to a target value (e.g., 1 to 100 P) may promote the flow of resin and cause entrapped air to be transported with the resin from regions of high pressure to low pressure and aid in the removal of entrapped air from the HTSC structure before reaching the resins' gelation point.

The first curing step 402 may begin by applying a first curing profile, wherein, during the first curing profile, the HTSC structure remains above the threshold temperature for an elapsed dwell time and the HTSC structure reaches a critical dwell temperature that is greater than the critical debulking temperature and reaches a critical dwell pressure. In some embodiments, the critical dwell pressure may be the same or higher than the critical debulking pressure. In some embodiments, the critical dwell pressure may range from about 30 to 150 psi. In some embodiments, the critical debulking pressure may be greater than 15 psi or range from about 15 to about 120 psi. In some embodiments, the critical debulking temperature at a desired debulking pressure may from about 80° F. to about 225° F., from 90° F. to 150° F. or from 90° F. to 120° F. In some embodiments, the debulking elapsed time at a desired critical debulking pressure and a critical debulking temperature may be adjusted as long as the first target bulk factor, first degree of cure are met, providing a void-free HTSC after the final cure. The debulking elapsed time might be less than 10 hours, 6 hours, 3 hours or from about 1 hours to about 5 hours. In some embodiments, the debulking elapsed time might be longer than about 10 hours or even up to 72 hours or more, depending on complexities of the HTSC, the varying thicknesses and total volume. The void-free is defined as the fully cured HTSC has less than 5% total void, less than 4%, less than 3%, less than 2%, less than 1%, based on a suitable non-destructive inspection method such as ultrasonic (UT), X-ray computed tomography (CT), micrographs of cross-sections, their derivatives, the alike or the similar.

One exemplary approach may be to maximize pressure as early as possible (and within the system and specification limits). The pressure may then held constant for the remainder of the cure. However, it may not always be advantageous to maximize pressure and in some situations a moderate pressure and a longer dwell time can be used to reduce entrapped gas, as opposed to maximum pressure for a shorter time period.

The HTSC structure may be heated in the female tool for the elapsed dwell time during which the HTSC structure reaches the critical dwell temperature and critical dwell pressure at the locations being measured on the part. The method then proceeding to the second curing step 404 after the elapsed dwell time has been reached.

The critical dwell temperature, critical dwell pressure and the elapsed dwell time are determined, prior to production, to produce the second target bulk factor, the second target degree of cure, and the target viscosity in the HTSC structure. Similar to step 302, the bulk factor process correlation determines a relationship between the bulk factor of the HTSC structure and temperature, pressure, and elapsed time, and the DOC process correlation determines a relationship between the DOC of the HTSC structure and temperature and elapsed time. A viscosity process correlation determines a relationship between the viscosity of the HTSC structure and temperature and elapsed time. The critical dwell temperature, the critical dwell pressure and the elapsed dwell time are determined based on the bulk factor process correlation, the DOC process correlation, and viscosity process correlation to produce the second target bulk factor, the second target DOC, and the target viscosity in the HTSC structure.

For example, referring again to FIG. 6, to determine the second target bulk factor and/or second degree of cure, a thermal history of the HTSC structure is considered. Based on the selected temperature profile 504, it can be determined by process correlation (e.g., bulk factor process correlation, degree of cure process correlation, viscosity process correlation, etc.) the material state of the HTSC structure corresponding to the selected temperature profile. For example, temperature profile 504 will result in bulk factor profile 602 and degree of cure profile 604. To select the second target bulk factor 612, the elapsed dwell time, critical dwell temperature, and critical dwell pressure are selected based on the bulk factor process correlation such that the second target bulk factor 612 is achieved at the end of the first curing step 402. The elapsed dwell time and the critical dwell temperature, based on the degree of cure process correlation, will result in the second target degree of cure 614. The elapsed dwell time and critical dwell temperature, based on a viscosity process correlation (discussed below), will result in the target viscosity (not depicted in FIG. 6) at the end of the first curing step 402. If the selected elapsed dwell time, critical dwell temperature, and critical dwell pressure do not result in the desired combination of second target bulk factor 612, second target degree of cure 614, and the target viscosity, then different values of elapsed dwell time, critical dwell temperature, and critical dwell pressure can be selected, to reach the desired combination of second target bulk factor, second target degree of cure, and targe viscosity at the end of the first curing step 402. The desired combination of second target bulk factor, second target degree of cure, and targe viscosity at the end of the first curing step 402 are selected to produce the desired void content at the end of the second cure step 404 of less than about 5%, less than about 3%, less than about 2%, or less than about 1%.

The viscosity process correlation is determined by at least one of a semi-empirical viscosity model of the HTSC structure, a plurality of viscosity simulations of the HTSC structure for a plurality of viscosity distinct process conditions, or experimental measurement.

A semi-empirical viscosity model may be a function of degree of cure at gelation, pressure, bulk modulus, temperature, Arrhenius constant, gas constant and other relevant parameters and constants. For example, an Arrhenius type relation activated by temperature and degree of cure, which was proposed by Lee, Loos and Springer to model viscosity of Hercules 3501-6 epoxy resin and modified by Convergent to include a maximum viscosity value. The predicted viscosity is not applicable beyond gelation.

The viscosity simulations may be part of the flow-compaction simulation outputs/models but also dependent on thermo-chemical models. The flow of resin and movement of the composite structure depend on pressure, temperatures, and boundary conditions. Examples of commercial software packages include RAVEN and COMPRO available from Convergent Manufacturing Technologies. The plurality of viscosity distinct process conditions includes at least one of a plurality of different heated environment temperatures utilized during heating the HTSC structure providing different heat transfer coefficients between the heated environment and the HTSC structure, a plurality of different heating rates for the HTSC structure, a plurality of different materials and thicknesses for the HTSC structure, or a plurality of different materials, thicknesses, thermal conductivity, heat capacity and density for the female tool.

Experimental measure may include rheology testing may be conducted to assess the deformation and/or flow of a material on the influence of imposed stresses. Rheology tests may include frequency sweeps, temperature ramps, profile-based, intrinsic viscosity and relative viscosity, capillary rheometry or suitable/applicable method. For example, a shear force may be applied to a sample (e.g., epoxy resin) at a given temperature and the corresponding output, e.g., flow behavior, is measured. These tests may be conducted on different materials at different temperatures. Tests may be performed on same materials that have different initial degree of cure.

Upon completion of the first curing step 402, the HTSC structure may have a bulk factor of less than about 5% and/or a DOC of less than about 50%, and/or a viscosity of higher than about 50 P. In some embodiments, the bulk factor at completion of the first curing step 402 may be less than about 5% and greater than about 1%. In some embodiments, the DOC at completion of the first curing step 402 may range from about 20% to less than about 45%. In some embodiments, the viscosity at completion of the first curing step 402 may be about 100 to about 10,000 P.

The objective of the debulking step 302 and the first cure step 402 may be to produce a composite structure that has achieved a target bulk factor (e.g., indicating good consolidation of the plies), has achieve a target viscosity threshold (e.g., poise to enable sufficient flow of resin and gaseous species), that has achieved a target degree of cure, after the target bulk factor has been achieved (i.e. the target bulk factor is achieved before the DoC advances to the stage where the matrix becomes immobilized and consolidation cannot progress further), and that has not experienced an exothermic reaction which may occur and become uncontrollable. To avoid an exothermic reaction, the temperature and ramp rates are controlled to ensure the energy required to polymerize the matrix is not significantly exceeded. Thick sections are often the most susceptible due to larger thermal gradients. If the first curing step 402 were not performed, the composite structure may not reach the desired target bulk factor, may potentially exceed process and/or specification limits, and potentially exhibit significant defects.

The HTSC structure having the second target bulk factor, the second target degree of cure, and the target viscosity may be furthered cured at the second curing step 404. The second curing step 404 begins applying a second curing profile, wherein, during the second curing profile, the HTSC structure remains above the critical dwell temperature for an elapsed final dwell time and the HTSC structure reaches a critical final dwell temperature that is greater than the critical dwell temperature. The HTSC structure may be heated above the threshold temperature for the elapsed final dwell time during which the HTSC structure reaches the critical final dwell temperature. Heating may be discontinuing after the critical final dwell temperature and the elapsed final dwell time have been reached.

The critical final dwell temperature and the elapsed final dwell time may be determined, prior to production, to produce a final target degree of cure and/or a target void content in the HTSC structure. The DOC process correlation determines a relationship between the DOC of the HTSC structure and temperature and elapsed time. A void content process correlation determines a relationship between the void content of the HTSC structure and temperature and elapsed time. The critical final dwell temperature and the elapsed final dwell time are selected based on the DOC process correlation and void content process correlation to produce the final target DOC and the target void content in the HTSC structure.

The void content process correlation is determined by at least one of a semi-empirical void content model of the HTSC structure, a plurality of void content simulations of the HTSC structure for a plurality of void content distinct process conditions, or experimental measurement.

A semi-empirical void content model may include a generalized empirical equation that enables the prediction of void content. The purpose of the void content model is to predict viscosity for a given cure cycle (time, temperature, ramp rates, and/or pressure). Parameters of the model may include empirical constants and parameters describing thermal, chemical and/or mechanical behavior of material makeup of the HTSC structure during curing.

The void content simulations include thermal-chemical and fiber-bed compaction models. Examples of commercial software packages include RAVEN and COMPRO available from Convergent Manufacturing Technologies. The plurality of void content distinct process conditions includes at least one of a plurality of different heated environment temperatures utilized during heating the HTSC structure providing different heat transfer coefficients between the heated environment and the HTSC structure, a plurality of different heating rates for the HTSC structure, a plurality of different pressures for the HTSC structure, a plurality of different materials and thicknesses for the HTSC structure, or a plurality of different materials, thicknesses, thermal conductivity, heat capacity and density for the female tool.

Experimental measure may include X-ray computed tomography, ultrasonic or visual thermography, micrographs of cross-sections, their derivatives, the alike or the similar.

Upon completion of the second curing step 404, the HTSC structure may have a void content or a total void percentage based on the total measured/scanned volume of interest of the HTSC of less than about 5% and/or a DOC of greater than about 80%. In some embodiments, the void content at completion of the second curing step 404 may be less than about 1%. In some embodiments, the DOC at completion of the second curing step 404 may range from about 85% to about 95% or more. The void content may not be uniform throughout the composition structure, for example, because of facets, corners, and/or non-uniform shape of the HTSC structure. For example, the overall void content may be about 1% or less and some localized regions of interest of the HTSC structure may have void content of about 5% or less.

### EXAMPLES

### Examples 1 to 3

In one exemplary embodiment, a model hollow composite laminate comprising a composite material comprising an aerospace grade epoxy composition of about 2 ft in length, about 1 ft in longer width and 0.5 ft in shorter width and variable thicknesses from 0.1 to 1 in thick was shaped using a collapsible mandrel, then bagged and inserted into a female tool. The mandrel was removed and the composite laminate inside the female tool was placed in an autoclave. A pre-determined cure profile comprising a debulking step 302, a first curing step 402 and a second curing step 404 was programmed into the autoclave. Based on pre-determined process correlations by either experiment, simulation, or both, where temperature, time and pressure were used to achieve the desired material state (i.e., the bulk factor and degree of cure) at the end of the debulking step may set up the conditions to achieve the next material state (i.e., the bulk factor, degree of cure, and viscosity) to be achieved at the end of the first curing step 402, and in turn the final material state to be achieved at the end of the second cure step 404, leading to reduced void content of the cured HTSC, elapsed times, critical temperatures, and critical pressures were selected for the debulking, first curing, and second curing steps. At the debulking step, an elapsed time, critical pressure, and critical temperature were applied to produce a debulked part. Temperature was monitored at several locations on the part including the leading and lagging temperature locations, and the method did not proceed to the next process step until the temperature at the lagging location reached the critical temperature and/or the elapsed time was reached. The temperature of the autoclave was increased for the first curing step, and the elapsed time, critical temperature and pressure were applied for the first curing step. Temperature was monitored, and the method did not proceed to the second curing step until the temperature at the lagging location reached the critical temperature and/or the elapsed time was reached. The temperature of the autoclave was again increased for the second curing step, and the elapsed time and critical temperature were applied for the second curing step. Temperature was monitored, and the method did cease heating until the critical temperature was reached at the lagging location on the part and/or the elapsed time was reached. The results of Examples 1 and 2 are shown in the table below. Example 1 resulted in a spar having a void content of about 1% at a DOC of about 90%. Example 2 resulted in a spar having a void content of about 0.5% at a DOC of about 92%. Example 3 resulted in a spar having a void content of about 1% at a DOC of about 90%. The above-referenced exemplary embodiment may be utilized to validate the method, for example, when determining the conditions needed to cure a part of a certain geometry and/or composition in tool of a certain geometry and/or composition. Once the validation is complete and the method has been determined, temperature may not be monitored during production of the part because the conditions for the part and tool are known.

The material states at the end of the debulking step and the first cure step enabling the void content of less than about 1% at the end of the second cure step. Similar void contents in larger scale hollow composite laminates, for example, on the order of 10 ft to 30 ft or larger in length, can be obtained provided similar material states are present at the end of the debulking step and the first cure step.

### Comparative Examples 1 and 2

The comparative example was prepared and performed in the same manner as Examples 1 and 2, except a debulking step was not used. The comparative example resulted in a spar having a void content of about 3% and about 5%, respectively at a DOC of about 90% as shown in the table below.

TABLE

| | Critical | Elapsed | Critical | Bulk | | | Void |
|---|---|---|---|---|---|---|---|
| | Temperature | Time | Pressure | Factor | Viscosity | DOC | Content |
| | (° F.) | (hr) | (psi) | (%) | (P) | (%) | (%) |
| EX 1 | | | | | | | |
| Before | | | | 13 | | 0 | |
| Cure | | | | | | | |
| Debulking | 150 | 3 | 115 | 8 | | 3 | |
| Step | | | | | | | |
| First Cure | 240 | 3 | 90 | 5 | 270 | 20 | |
| Step | | | | | (0.35″ | | |
| | | | | | thick)- | | |
| | | | | | 290 | | |
| | | | | | (0.425″ | | |
| | | | | | thick) | | |
| Second | 350 | 6 | | | | 90 | 1 |
| Cure Step | | | | | | | |
| EX 2 | | | | | | | |
| Before | | | | 13 | | 0 | |
| Cure | | | | | | | |
| Debulking | 115 | 3 | 115 | 10 | | 0.5 | |
| Step | | | | | | | |
| First Cure | 270 | 3 | 115 | 3 | 240 (0.1″ | 30 | |
| Step | | | | | thick)- | | |
| | | | | | 330 (1″ | | |
| | | | | | thick) | | |
| Second | 350 | 6 | | | | 90 | 0.5 |
| Cure Step | | | | | | | |
| EX 3 | | | | | | | |
| Before | | | | 20 | | 0 | |
| Cure | | | | | | | |
| Debulking | 115 | 3 | 115 | 15 | | 0.5 | |
| Step | | | | | | | |
| First Cure | 290 | 3 | 115 | 2 | 310 (0.1″ | 40 | |
| Step | | | | | thick)- | | |
| | | | | | 450 (1″ | | |
| | | | | | thick) | | |
| Second | 350 | 6 | | | | 90 | 1 |
| Cure Step | | | | | | | |
| COMP | | | | | | | |
| EX 1 | | | | | | | |
| Before | | | | 13 | | 0 | |
| Cure | | | | | | | |
| Debulking | | | | | | | |
| Step | | | | | | | |
| First Cure | 220 | 7 | 115 | 8 | 450 | 30 | |
| Step | | | | | (0.35″ | | |
| | | | | | thick)- | | |
| | | | | | 500 | | |
| | | | | | (0.45″ | | |
| | | | | | thick) | | |
| Second | 350 | 8 | | | | 90 | 3 |
| Cure Step | | | | | | | |
| COMP | | | | | | | |
| EX 2 | | | | | | | |
| Before | | | | 20 | | 0 | |
| Cure | | | | | | | |
| Debulking | | | | | | | |
| Step | | | | | | | |
| First Cure | 240 | 7 | 115 | 10 | 380 (0.1″ | 40 | |
| Step | | | | | thick)- | | |
| | | | | | 620 (1″ | | |
| | | | | | thick) | | |
| Second | 350 | 8 | | | | 90 | 5 |
| Cure Step | | | | | | | |

In an exemplary embodiment of the present disclosure, a method of curing a hollow thermoset composite (HTSC) structure comprising debulking a hollow thermoset composite (HTSC) structure in a female tool to have a first target bulk factor; and curing the debulked HTSC structure.

The method of the immediately preceding paragraphs, wherein debulking the HTSC structure to a first target bulk factor further comprises applying a debulking profile, wherein, during the debulking profile, the HTSC structure remains above a threshold temperature for an elapsed debulking time and the HTSC structure reaches a critical debulking temperature that is greater than the threshold temperature and reaches a critical debulking pressure; and proceeding to the curing step after the first target bulk factor has been reached.

The method of any of the two preceding paragraphs, further comprising during heating of the HTSC structure, monitoring an actual temperature and monitoring an actual pressure, wherein the actual temperature comprises at least one of an actual temperature of the HTSC structure, an actual temperature of the female tool, an actual temperature of air at one or more locations between the female tool and the HTSC structure, and wherein an actual pressure comprises an actual pressure being applied by a cure equipment to the HTSC structure.

The method of any of the three preceding paragraphs, comprising adjusting at least one of the heating or pressure of the cure equipment or the elapsed debulking time in response to the monitored actual temperature and actual pressure to achieve the desired first target bulk factor.

The method of any of the four preceding paragraphs, wherein monitoring the actual temperature of the HTSC structure during debulking the HTSC structure further comprises monitoring a plurality of actual temperatures of the HTSC at a plurality of spaced-apart locations on the HTSC structure.

The method of any of the five preceding paragraphs, further comprising comparing the actual temperatures of the HTSC at the plurality of spaced-apart locations and adjusting at least one of the heating or pressure of the cure equipment or the elapsed debulking time in response to the monitored actual temperatures to obtain the desired first target bulk factor.

The method of any of the six preceding paragraphs, wherein the debulking profile is determined such that the critical debulking temperature, critical debulking pressure and the elapsed debulking time produce the first target bulk factor in the HTSC structure.

The method of any of the seven preceding paragraphs, wherein a bulk factor process correlation determines a relationship between the bulk factor of the HTSC structure and temperature, pressure, and time, and wherein one or more of the critical debulking temperature, the critical debulking pressure and the elapsed debulking time are determined by the bulk factor process correlation.

The method of any of the eight preceding paragraphs, wherein the bulk factor process correlation is determined from at least one of: (i) a semi-empirical bulk factor model of the HTSC structure; (ii) a plurality of bulk factor simulations of the HTSC structure for a plurality of bulk factor distinct process conditions, wherein the bulk factor simulations include thermal-chemical and flow compaction models; or (iii) experimental measurement.

The method of any of the nine preceding paragraphs, wherein the plurality of bulk factor distinct process conditions includes at least one of: (i) a plurality of different heated environment temperatures utilized during heating the HTSC structure providing different heat transfer coefficients among at least the heated environment, the female tool, and the HTSC structure; (ii) a plurality of different heating rates for the HTSC structure; (iii) a plurality of different pressures applied to the HTSC structure; (iv) a plurality of different materials and thicknesses for the HTSC structure; or (v) a plurality of different materials, thicknesses, thermal conductivity, heat capacity and density for the female tool.

The method of any of the ten preceding paragraphs, wherein the critical debulking temperature and the elapsed debulking time are further determined to produce a first target degree of cure (DOC) in the HTSC structure.

The method of any of the eleven preceding paragraphs, wherein a DOC process correlation determines a relationship between the DOC in the HTSC structure and temperature and time, wherein the critical debulking temperature and the elapsed debulking time are further determined by the DOC process correlation to produce the first target DOC in the HTSC structure.

The method of any of the twelve preceding paragraphs, wherein the DOC process correlation is determined from at least one of: (i) a calibration curve having a functional relation between DOC and the critical debulking temperature and the elapsed debulking time; (ii) a lookup table having paired values of the critical debulking temperature and the elapsed debulking time that produce the first target DOC; (iii) a semi-empirical DOC model of the HTSC structure; (iv) a plurality of DOC simulations of the HTSC structure for a plurality of DOC distinct process conditions, wherein the DOC simulations include thermal-chemical models; or (v) experimental measurement.

The method of any of the thirteen preceding paragraphs, wherein the plurality of DOC distinct process conditions includes at least one of: (i) a plurality of different heated environment temperatures utilized during heating the HTSC structure providing different heat transfer coefficients among at least the heated environment, the female tool, and the HTSC structure; (ii) a plurality of different heating rates for the HTSC structure; (iii) a plurality of different materials and thicknesses for the HTSC structure; (iv) a plurality of different materials, thicknesses, thermal conductivity, heat capacity and density for the female tool.

The method of any of the fourteen preceding paragraphs, wherein curing the debulked HTSC structure further comprises: (a) curing the debulked HTSC structure to have a second target bulk factor, a second target DOC and a target viscosity, wherein the second target bulk factor and the second target DOC are greater than the first target bulk factor and first target DOC, respectively; and (b) curing the HTSC structure resulting from step (a) to have a final target DOC, wherein the final target DOC is greater than the second target DOC.

The method of any of the fifteen preceding paragraphs, wherein step (a) further comprises applying a first curing profile, wherein, during the first curing profile, the HTSC structure remains above the critical debulking temperature for an elapsed dwell time and the HTSC structure reaches a critical dwell temperature that is greater than the critical debulking temperature and reaches a critical dwell pressure; and proceeding to step (b) after the second target bulk factor and second target DOC has been reached.

The method of any of the sixteen preceding paragraphs, wherein the critical dwell temperature, critical dwell pressure and the elapsed dwell time are determined to produce the second target bulk factor, the second target degree of cure, and the target viscosity in the HTSC structure.

The method of any of the seventeen preceding paragraphs, wherein a bulk factor process correlation determines a relationship between the bulk factor of the HTSC structure and temperature, pressure, and time, wherein a DOC process correlation determines a relationship between the DOC of the HTSC structure and temperature and elapsed time, wherein a viscosity process correlation determines a relationship between the viscosity of the HTSC structure and temperature and elapsed time, and wherein the critical dwell temperature, the critical dwell pressure and the elapsed dwell time are determined by the bulk factor process correlation, the DOC process correlation, and viscosity process correlation to produce the second target bulk factor, the second target DOC, and the target viscosity in the HTSC structure.

The method of any of the eighteen preceding paragraphs, wherein the viscosity process correlation is determined by at least one of: (i) a semi-empirical viscosity model of the HTSC structure; (ii) a plurality of viscosity simulations of the HTSC structure for a plurality of viscosity distinct process conditions, wherein the viscosity simulations include thermal-chemical models; or (iii) experimental measurement.

The method of any of the nineteen preceding paragraphs, wherein the plurality of viscosity distinct process conditions includes at least one of: (i) a plurality of different heated environment temperatures utilized during heating the HTSC structure providing different heat transfer coefficients among at least the heated environment, the female tool, and the HTSC structure; (ii) a plurality of different heating rates for the HTSC structure; (iii) a plurality of different materials and thicknesses for the HTSC structure; or (iv) a plurality of different materials, thicknesses, thermal conductivity, heat capacity and density for the female tool.

The method of any of the twenty preceding paragraphs, further comprising during heating of the HTSC structure in step (a), monitoring an actual temperature and monitoring an actual pressure, wherein the actual temperature comprises at least one of an actual temperature of the HTSC structure, an actual temperature of the female tool, an actual temperature of air at one or more locations between the female tool and the HTSC structure, and wherein an actual pressure comprises an actual pressure being applied by the cure equipment.

The method of any of the twenty one preceding paragraphs, further comprising adjusting at least one of the heating or pressure of the female tool in response to the monitored actual temperature and actual pressure to achieve the desired second target bulk factor and second target DOC.

The method of any of the twenty-two preceding paragraphs, wherein monitoring the actual temperature of the HTSC structure during heating in step (a) comprises: monitoring a plurality of actual temperatures of the HTSC at a plurality of spaced-apart locations on the HTSC structure.

The method of any of the twenty-three preceding paragraphs, further comprising comparing the actual temperatures of the HTSC at the plurality of spaced-apart locations and adjusting at least one of the heating or pressure of the female tool or the elapsed dwell time in response to the monitored actual temperatures to obtain the desired second target bulk factor and second target DOC at each of the spaced-apart locations on the HTSC structure.

The method of any of the twenty-four preceding paragraphs, wherein the method proceeds to step (b) after the second target bulk factor and second target DOC are reached.

The method of any of the twenty-five preceding paragraphs, wherein step (b) further comprises applying a second curing profile, wherein, during the second curing profile, the HTSC structure remains above the critical dwell temperature for an elapsed final dwell time and the HTSC structure reaches a critical final dwell temperature that is greater than the critical dwell temperature; and discontinuing heating after the critical final dwell temperature and at least the elapsed final dwell time have been reached.

The method of any of the twenty-six preceding paragraphs, wherein the critical final dwell temperature and the elapsed final dwell time are determined to produce the final target degree of cure and a target void content in the HTSC structure.

The method of any of the twenty-seven preceding paragraphs, wherein a DOC process correlation determines a relationship between the DOC of the HTSC structure and temperature and time, wherein a void content process correlation determines a relationship between the void content of the HTSC structure and temperature and elapsed time, and wherein the critical final dwell temperature, and the elapsed final dwell time are determined by the DOC process correlation and void content process correlation to produce the final target DOC and the target void content in the HTSC structure.

The method of any of the twenty-eight preceding paragraphs, wherein the void content process correlation is determined by at least one of (i) a semi-empirical void content model of the HTSC structure; (ii) a plurality of void content simulations of the HTSC structure for a plurality of void content distinct process conditions, wherein the void content simulations include thermal-chemical and fiber-bed compaction models; or (iii) experimental measurement.

The method of any of the twenty-nine preceding paragraphs, wherein the plurality of void content distinct process conditions includes at least one of (i) a plurality of different heated environment temperatures utilized during heating the HTSC structure providing different heat transfer coefficients among at least the heated environment, the female tool, and the HTSC structure; (ii) a plurality of different heating rates for the HTSC structure; (iii) a plurality of different pressures for the HTSC structure; (iv) a plurality of different materials and thicknesses for the HTSC structure; or (v) a plurality of different materials, thicknesses, thermal conductivity, heat capacity and density for the female tool.

The method of any of the thirty preceding paragraphs, wherein the HTSC structure has a cavity extending therethrough and along a length thereof, where the walls of the HTSC structure are a laminate, and wherein the laminate comprises a plurality of plies.

The method of any of the thirty-one preceding paragraphs, wherein the HTSC structure has at least two different cross-sections along the length thereof.

The method of any of the thirty-two preceding paragraphs, where, prior to debulking the HTSC structure, further comprising placing the HTSC structure in a first container; and then placing the container including the HTSC structure in the female tool; wherein the first container has one or more openings, wherein the one or more openings are coupled to at least one of an air source, a vacuum source, or thermocouple.

The method of any of the thirty-three preceding paragraphs, wherein, prior to placing the HTSC structure in the container, further comprising placing a second container into the cavity of the HTSC structure, wherein the second container has one or more openings, wherein the one or more openings are coupled to at least one of an air source, a vacuum source, or a thermocouple.

A hollow thermoset composite structure prepared by the method of any of the preceding thirty-four paragraphs.

In an exemplary embodiment of the present disclosure, a system comprises a female tool configured to receive a hollow thermoset composite (HTSC) structure, where the system is configured to perform the method of any of the preceding thirty-five paragraphs.

The system of the immediately preceding paragraph, further comprising a first container for surrounding the HTSC structure while the HTSC structure is present in the female tool; and a second container for filling a cavity of the HTSC structure, each of the first and second containers having one or more openings, wherein the one or more openings are coupled to at least one of an air source, a vacuum source, or a thermocouple.

The system of any of the two preceding paragraphs, further comprising a plurality of thermocouples, where the thermocouples are placed at different locations throughout the female tool and along the HTSC structure, wherein the thermocouples monitor one or more of a temperature of the HTSC structure, a temperature of the female tool, a temperature of air at one or more locations between the female tool and the HTSC structure.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended statements to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method of curing a hollow thermoset composite (HTSC) structure, comprising:
debulking a hollow thermoset composite (HTSC) structure in a female tool to have a first target bulk factor; and
curing the debulked HTSC structure.

2. The method of claim 1, wherein debulking the HTSC structure to a first target bulk factor further comprises:
applying a debulking profile, wherein, during the debulking profile, the HTSC structure remains above a threshold temperature for an elapsed debulking time and the HTSC structure reaches a critical debulking temperature that is greater than the threshold temperature and reaches a critical debulking pressure; and
proceeding to the curing step after the first target bulk factor has been reached.

3. The method of claim 2,
wherein the debulking profile is determined such that the critical debulking temperature, critical debulking pressure and the elapsed debulking time produce the first target bulk factor in the HTSC structure.

4. The method of claim 3,
wherein a bulk factor process correlation determines a relationship between the bulk factor of the HTSC structure and temperature, pressure, and time, and
wherein one or more of the critical debulking temperature, the critical debulking pressure and the elapsed debulking time are determined by the bulk factor process correlation.

5. The method of claim 4, wherein the bulk factor process correlation is determined from at least one of:
(i) a semi-empirical bulk factor model of the HTSC structure;
(ii) a plurality of bulk factor simulations of the HTSC structure for a plurality of bulk factor distinct process conditions, wherein the bulk factor simulations include thermal-chemical and flow compaction models; or
(iii) experimental measurement.

6. The method of claim 5, wherein the plurality of bulk factor distinct process conditions includes at least one of:
(i) a plurality of different heated environment temperatures utilized during heating the HTSC structure providing different heat transfer coefficients among at least the heated environment, the female tool, and the HTSC structure;
(ii) a plurality of different heating rates for the HTSC structure;
(iii) a plurality of different pressures applied to the HTSC structure;
(iv) a plurality of different materials and thicknesses for the HTSC structure; or
(v) a plurality of different materials, thicknesses, thermal conductivity, heat capacity and density for the female tool.

7. The method of claim 3, wherein the critical debulking temperature and the elapsed debulking time are further determined to produce a first target degree of cure (DOC) in the HTSC structure.

8. The method of claim 7, wherein a DOC process correlation determines a relationship between the DOC in the HTSC structure and temperature and time,
wherein the critical debulking temperature and the elapsed debulking time are further determined by the DOC process correlation to produce the first target DOC in the HTSC structure.

9. The method of claim 8, wherein the DOC process correlation is determined from at least one of:
(i) a calibration curve having a functional relation between DOC and the critical debulking temperature and the elapsed debulking time;
(ii) a lookup table having paired values of the critical debulking temperature and the elapsed debulking time that produce the first target DOC;
(iii) a semi-empirical DOC model of the HTSC structure;
(iv) a plurality of DOC simulations of the HTSC structure for a plurality of DOC distinct process conditions, wherein the DOC simulations include thermal-chemical models; or
(v) experimental measurement.

10. The method of claim 9, wherein the plurality of DOC distinct process conditions includes at least one of:
(i) a plurality of different heated environment temperatures utilized during heating the HTSC structure providing different heat transfer coefficients among at least the heated environment, the female tool, and the HTSC structure;
(ii) a plurality of different heating rates for the HTSC structure;
(iii) a plurality of different materials and thicknesses for the HTSC structure;
(iv) a plurality of different materials, thicknesses, thermal conductivity, heat capacity and density for the female tool.

11. The method of claim 7, wherein curing the debulked HTSC structure further comprises:
(a) curing the debulked HTSC structure to have a second target bulk factor, a second target DOC and a target viscosity, wherein the second target bulk factor and the second target DOC are greater than the first target bulk factor and first target DOC, respectively; and
(b) curing the HTSC structure resulting from step (a) to have a final target DOC, wherein the final target DOC is greater than the second target DOC.

12. The method of claim 11, wherein step (a) further comprises:
applying a first curing profile, wherein, during the first curing profile, the HTSC structure remains above the critical debulking temperature for an elapsed dwell time and the HTSC structure reaches a critical dwell temperature that is greater than the critical debulking temperature and reaches a critical dwell pressure; and
proceeding to step (b) after the second target bulk factor and second target DOC has been reached.

13. The method of claim 12, wherein the critical dwell temperature, critical dwell pressure and the elapsed dwell time are determined to produce the second target bulk factor, the second target degree of cure, and the target viscosity in the HTSC structure.

14. The method of claim 13, wherein a bulk factor process correlation determines a relationship between the bulk factor of the HTSC structure and temperature, pressure, and time,
wherein a DOC process correlation determines a relationship between the DOC of the HTSC structure and temperature and elapsed time,
wherein a viscosity process correlation determines a relationship between the viscosity of the HTSC structure and temperature and elapsed time, and
wherein the critical dwell temperature, the critical dwell pressure and the elapsed dwell time are determined by the bulk factor process correlation, the DOC process correlation, and viscosity process correlation to produce the second target bulk factor, the second target DOC, and the target viscosity in the HTSC structure.

15. The method of claim 12, wherein step (b) further comprises:
applying a second curing profile, wherein, during the second curing profile, the HTSC structure remains above the critical dwell temperature for an elapsed final dwell time and the HTSC structure reaches a critical final dwell temperature that is greater than the critical dwell temperature; and
discontinuing heating after the critical final dwell temperature and at least the elapsed final dwell time have been reached.

16. The method of claim 15, wherein the critical final dwell temperature and the elapsed final dwell time are determined to produce the final target degree of cure and a target void content in the HTSC structure.

17. The method of claim 16, wherein a DOC process correlation determines a relationship between the DOC of the HTSC structure and temperature and time,
wherein a void content process correlation determines a relationship between the void content of the HTSC structure and temperature and elapsed time, and
wherein the critical final dwell temperature, and the elapsed final dwell time are determined by the DOC process correlation and void content process correlation to produce the final target DOC and the target void content in the HTSC structure.

18. The method of claim 17, wherein the void content process correlation is determined by at least one of:
(i) a semi-empirical void content model of the HTSC structure;
(ii) a plurality of void content simulations of the HTSC structure for a plurality of void content distinct process conditions, wherein the void content simulations include thermal-chemical and fiber-bed compaction models; or
(iii) experimental measurement.

19. The method of claim 18, wherein the plurality of void content distinct process conditions includes at least one of:
(i) a plurality of different heated environment temperatures utilized during heating the HTSC structure providing different heat transfer coefficients among at least the heated environment, the female tool, and the HTSC structure;
(ii) a plurality of different heating rates for the HTSC structure;
(iii) a plurality of different pressures for the HTSC structure;
(iv) a plurality of different materials and thicknesses for the HTSC structure; or
(v) a plurality of different materials, thicknesses, thermal conductivity, heat capacity and density for the female tool.

20. The method of claim 1, wherein the HTSC structure has a cavity extending therethrough and along a length thereof, where the walls of the HTSC structure are a laminate, and wherein the laminate comprises a plurality of plies.
